(19) United States
(12) Patent Application Publication
(10) Pub. No.: US 2014/0274424 A1
(43) Pub. Date: Sep. 18, 2014

(54) CONNECTING DEVICE AND METHOD FOR PRODUCING IT

(71) Applicant: THYSSENKRUPP PRESTA AG, Eschen (LI)

(72) Inventors: Michael Brassel, Buchs (CH); Reinhard Bertsch, Röthis (AT)

(73) Assignee: THYSSENKRUPP PRESTA AG, Eschen (LI)

(21) Appl. No.: 14/352,226

(22) PCT Filed: Oct. 17, 2012
(86) PCT No.: PCT/EP2012/004338

§ 371 Date: Apr. 16, 2014

(30) Foreign Application Priority Data
Oct. 21, 2011 (DE) 102011116571.5

(51) Int. Cl. F16D 3/26

(52) U.S. Cl. CPC F16D 3/26
USPC 464/134; 29/893.1

(57) ABSTRACT

The invention relates to a connecting device comprising a joint yoke and a shaft, wherein, in a recess, the joint yoke has a toothing running transversely to a longitudinal axis and the shaft has an elongate toothing. The invention also relates to a method for producing a connecting device of this kind.

The present invention relates to a connecting device of a drive shaft having two interlocking parts according to the preamble of independent claim 1. The invention also relates to a method for producing a shaft-yoke connection according to the preamble of independent claim 6.

Drive shafts are principally used where flexible connections are no longer sufficient for transferring a torque in the case of non-aligning axes of rotation or parts which move towards each other. Drive shafts are also used for length compensation.

A drive shaft comprises at least one yoke joint which is connected to a shaft. To transfer the torques the contact or connecting faces of the two components are usually non-positively and/or frictionally connected together in the case of connections of this kind, which are also called shaft-hub connections. For this purpose the contact faces are provided with a knurling (toothing) which ensures good non-positive or frictional connection.

The connecting face of the joint yoke, which is arranged in a recess, is provided with a toothing oriented in a longitudinal direction, and this is introduced by means of a broaching operation. This is a machining or cutting operation. The connecting face of the shaft has a toothing oriented in the radial direction, i.e. elevations and indentations which extend in the circumferential direction of the shaft. A joint yoke connection of this kind is known from 10 2006 051 129 B3.

Assembly of the joint yoke with the shaft causes the risk of a slight deformation of the geometry of the components. A deformation of geometry can also occur due to the broaching operation since the forces acting on the component during broaching are considerable. A deformation of this kind can therefore have adverse effects on positional accuracy during subsequent use of the drive shaft.

It is therefore an object of the present invention to develop the connecting device of joint yoke and shaft mentioned in the introduction and the method for its production and to provide a connecting device and a method with which greater positional accuracy can be achieved.

A connecting device for achieving the object according to the invention has the features of independent claim 1. This is accordingly a connecting device of a drive shaft having two interlocking parts, comprising a joint yoke and a shaft engaged with the joint yoke, wherein the joint yoke has a recess for receiving the shaft and the joint yoke and, in the region of a connecting face of joint yoke and shaft, the shaft has a toothing, and wherein the toothing of the joint yoke is substantially radially arranged and the toothing of the shaft is substantially axially arranged and wherein the toothing of joint yoke is a thread. With a toothing radially arranged in the recess, i.e. encircling at the inner side of the recess in the circumferential direction, deformation during assembly and also during production of the toothing can be largely avoided. The forces which act can be better absorbed by way of a rotating movement sequence during production of the toothing, for which reason such excessive, one-sided forces cannot occur.

According to a development of the invention the thread can be a clockwise-turning or anticlockwise-turning thread, in particular an internal thread. In the case of an internal thread the recess of the joint yoke has a continuous spiral-like toothing with which the shaft is engaged. It is also possible for the thread to be a V-, buttress, round, trapezoidal or flat thread. The components can be coupled better with the different thread designs, and primarily as a function of the drive shaft geometry and material characteristics.

It may also advantageously be provided that the thread has one, two or more thread turn(s). This can also strengthen the connection further.

According to a further development of the invention the toothing of the shaft can have elongate toothing, in particular the toothing may be formed from a series of radial projections and indentations which extend substantially in a longitudinal extension of the shaft. This toothing corresponds with the toothing of the recess and brings about improved positive and non-positive connection of the two components.

The object is also achieved with a method having the features of independent claim 7. With a method of this kind for producing a, in particular, positive and non-positive shaft-yoke connection, a shaft is substantially concentrically arranged in a recess of a joint yoke and the shaft and the joint yoke are provided with a toothing, wherein, in a region of a connecting face inside the recess, the joint yoke is provided with a thread and the shaft is provided with toothing running substantially in the axial direction.

According to a preferred embodiment of the invention the shaft may [ ] in the region of a connecting face with a sequence of radial elevations and indentations.

According to a preferred development the thread can be rolled or cut. The toothing can consequently be introduced into the recess particularly gently and deformations counteracted.

It may also advantageously be provided that the shaft is pressed with its elongate toothing into the recess with the thread and is caulked at a leading end in an end position, wherein the shaft and the joint yoke are joined together with press fit.

Further advantageous embodiments of the connecting device and the method can be part of the subclaims.

A preferred embodiment of the invention will be explained in more detail below with reference to the drawings, in which:

FIG. 1 shows a side view of a joint yoke and a shaft according to one embodiment of the invention, and these are not yet connected together,

FIG. 2 shows a lateral section through the joint yoke and shaft

FIG. 3 shows a side view of a connection of a joint yoke and a shaft according to one embodiment of the invention,

FIG. 4 shows a perspective view [of] a joint yoke and shaft which are not yet connected together, and

FIG. 5 shows a perspective view of a connection [of] a joint yoke and a shaft.

The figures show a yoke joint 10 and a shaft 11 which together form a connecting device 13 comprising yoke joint 10 and shaft 11.

The joint yoke 10 comprises a yoke base 14 with two legs 15 extending in parallel therefrom, and these are connected at an end opposing the yoke base 14 to a cross member 16. A recess 17 is arranged in the yoke base 14, and this extends centrally through the yoke base 14.

Provided in the recess 17, also called a passage, through-hole or opening, is a toothing which is shown in FIG. 4. The toothing is indicated in FIG. 2. The toothing is in the form of a thread 18, for which reason the toothing in the recess 17 is an internal thread.

The thread 18 therefore has a continuous spiral-like thread turn which, in the form of a notch, runs through a substantially cylindrical wall of the recess. The elevation which protrudes at least with respect to the notch forms the toothing. In a longitudinal extension of the recess elevations and indentations alternate with each other through the thread 18, so a substantially radial toothing results in the recess 17. The elevations and indentations are arranged at an angle to the imaginary transverse axis of the recess 17 according to the pitch of the thread turn.

The thread 18 is not specified further in the figures although, according to the embodiment, it is designed as a right-hand or left-hand thread 18. Furthermore, the thread flanks, i.e. the elevations and indentations (notch), may also have different designs. Embodiments with V-threads, buttress threads, round threads, trapezoidal threads or flat threads are provided. In addition, these embodiments may also be combined with more than one thread turn, so by way of example an embodiment with a trapezoidal thread and two thread turns is provided. The other examples may be combined with each other as desired. The thread advantageously has a spacing from the smallest internal diameter to the largest internal diameter of about 0.8 to 0.2 mm. At least eight thread elevations, or thread turns, are advantageously engaged in the connection.

The figures also show a shaft 11 which can be arranged in the recess 17 of the yoke joint. This is shown at least in FIGS. 3 and 5. For the shaft 11 to be received in the recess 17 the shaft 11 has a receiving region 19 with a contact face which is provided with a toothing 20. The toothing is formed from elevations and indentations which extend in the radial direction of the receiving region 19. The spacing between elevations and indentations of the toothing is advantageously in the region of 0.8 to 2 mm. It is conceivable and possible to introduce or mould the toothing during a reshaping process or a casting process to produce the switch [shaft] 11.

To couple the shaft 11 to the joint yoke the receiving region 19 is arranged in the recess 17, wherein, as shown in FIGS. 3 and 5, the two sections correspond with each other. This primarily relates to the size of the two components. The two components are connected together positively and non-positively, ensuring optimum force transfer from shaft 11 to the joint yoke 10 or vice versa.

Production of the toothing in the joint yoke 10 in particular is simple and requires little force. The production process is a continuous one as a result of the fact that the toothing is designed as a thread 18. The thread 18 can either be rolled or cut in this connection. Insertion of a thread 18 is easy to achieve in terms of production engineering. It is conceivable and possible to introduce or mould the thread during a reshaping process or a casting process to produce the yoke. Production of the knurling or toothing in the receiving region 19 of the shaft 11 is also straightforward.

In a second operation, following production of the toothing in both the recess 17 and the receiving region 19, the two components, yoke joint 10 and shaft 11, are pressed together and caulked. Positive and non-positive connection is therefore created between the two components since the knurl toothing formatively embeds itself in the other transverse toothing in each case. Non-positive connection is produced in the longitudinal direction in addition to in the circumferential direction due to corresponding resilience.

The invention is primarily used in connections for a double cardan yoke or normal yoke-shaft/journal connections or the like. The thread can be introduced into any joint yokes with cylindrical recess and be connected to an elongate toothing of a corresponding component.

1. A connecting device of a drive shaft having two interlocking parts, comprising:
a joint yoke; and
a shaft configured to be engaged with the joint yoke,
wherein the joint yoke has a recess for receiving the shaft,
wherein the joint yoke and the shaft have toothing in a region of a connecting face of the joint yoke and the shaft,
wherein the toothing of the joint yoke is arranged substantially radially and the toothing of the shaft is arranged substantially axially, and
wherein the toothing of the joint yoke is a thread.

2. The connecting device of a drive shaft according to claim 1, wherein the thread is a clockwise-turning or anticlockwise-turning internal thread.

3. The connecting device of a drive shaft according to claim 1, wherein the thread a V-, buttress, round, trapezoidal or flat thread.

4. The connecting device of a drive shaft according to claim 1, wherein the thread has one, two or more thread turns.

5. The connecting device of a drive shaft according to claim 1, wherein the toothing of the shaft has elongate toothing formed from a sequence of radial projections and indentations which extend substantially in a longitudinal extension of the shaft.

6. A method of producing a non-positive and positive shaft-yoke connection, wherein a shaft is substantially concentrically arranged in a recess of a joint yoke and the shaft and the joint yoke are provided with a toothing, the method including:
providing a thread in a region of a connecting face inside a recess of the joint yoke; and
providing the shaft with toothing running substantially in an axial direction of the shaft.

7. The method according to claim 6, further comprising:
providing the shaft with a sequence of radial elevations and indentations in the region of the connecting face.

8. The method according to claim 6, wherein providing the thread comprises rolling the thread.

9. The method according to claim 6, wherein providing the thread comprises cutting the thread.

10. The method according to claim 6, further comprising:
pressing the shaft, wherein the toothing of the shaft is elongate toothing, in the recess with the thread; and
and caulking the shaft in an end position at a leading end,
wherein the shaft and the joint yoke are joined together with a press fit.
